(19) United States
(12) Patent Application Publication
(10) Pub. No.: US 2007/0060440 A1
(43) Pub. Date: Mar. 15, 2007

(54) Speed reduction system for generating high torque

(76) Inventor: Pao-Ling Lee, Taipei (TW)

Correspondence Address: BRUCE H. TROXELL, SUITE 1404, 5205 LEESBURG PIKE, FALLS CHURCH, VA, 22041, US

(21) Appl. No.: 11/214,823

(22) Filed: Aug. 31, 2005

(51) Int. Cl. F16H 57/08

(52) U.S. Cl. 475/337

(57) ABSTRACT

A speed reduction system includes a rotating source, a first ring gear, a first holding seat, a first gear set disposed on the first holding seat, meshed with the first ring gear and coupled to an output shaft of the rotating source, a second ring gear juxtaposed to the first ring gear, a second holding seat, and a second gear set disposed on the second holding seat, meshed with the second ring gear and coupled to a central axle of the first holding seat. Activation of the rotating source results in synchronous rotation of the first gear set and the first holding seat, which, in turn, results in relative rotation between the second ring gear and second holding seat so as to provide a torque, by virtue of interconnection between the central axle of the first holding seat and the second gear set.

### FIELD OF THE INVENTION

The invention relates to a speed reduction system, more particularly to a speed reduction system that is adapted to reduce the speed in multi-steps so as to generate a high torque for rotating an article.

### BACKGROUND OF THE INVENTION

A speed reduction system is usually employed within a machine or a driving source in order to provide different rotation speed thereof. Power-operated machines (such as motors, transport vehicles, punching apparatus or milling device) are indispensable to our daily life, and generally include a speed reduction system for generating different speed rate and high torque.

A planetary gear system is usually employed in a conventional speed reduction system. FIG. 1 shows the conventional planetary gear system 10, and generally includes a sun gear 101, a ring gear 104 surrounding the sun gear 101, a holding seat 103 disposed within the ring gear 104, and a planet gear set 102 mounted on the holding seat 103 in such a manner to be meshed with the ring gear 104. The sun gear 101 is coupled to an output shaft of a rotating source (not shown) such that actuation of the rotating source results in rotation of the planet gear set 102 in lower speed with respect to the ring gear 104, which, in turn, generates a torque for driving the holding seat 103.

However, some of the machines require high torque at the beginning of the operation. The aforesaid planetary gear system 10 is unable produce high-speed ratio in order to satisfy the customer's need. The dimension and size of the ring gear 104 though can be increased in order to provide high speed ration, but such arrangement may result in indefinite meshing among the teeth of the gears due to its bulky size. Hence, the utility range of the conventional speed reduction system 10 is limited.

Referring to FIG. 2, another conventional speed reduction system is proposed in order to provide two-step speed reduction effect thereof. As illustrated, the conventional speed reduction system includes a hub housing 18, a cover plate 16 secured on the hub housing 18, a driving gear 17 secured on an inner side of the cover plate 16, and a motor assembly disposed within the hub housing 18 so as to be concealed by the cover plate 16. The motor assembly includes a left casing half 11, a right casing half 13, an output shaft 110 extending through the left and right casing halves 11,13 for journaling to the hub housing 18 and the cover plate 16, a central gear 12 disposed within the left casing half 11 and fixed on the output shaft 110, a first gear 14 mounted within the right casing half 13 and meshed with the central gear 12, a second gear 15 mounted on the right casing half 13 opposite to the first gear 14 and coupled co-axially thereto via a coupler shaft 131.

The first gear 14 has the number of teeth N₁ that is greater than the numbers of teeth N_{cen}, N₂ of the central gear 12 and the second gear 15. The driving gear 17 has the number of teeth Nₒᵤₜ that is greater than the number of teeth N₂ of the second gear 15. Actuation of the motor assembly results in driving of the hub housing 18 together with the cover plate 16. Under such condition, the teeth ratio between the central gear 12 and the first gear 14 is N_{cen}:N₁ while the teeth ratio between the second gear 15 and the driving gear 17 is N₂:Nₒᵤₜ. Therefore, the reduction speed ratio between the central gear 12 and the driving gear 17 is (N₁/N_{cen})×(Nₒᵤₜ/N₂) that is generally greater than 1.

As shown in FIG. 2, the first and second gears 14, 15 are co-axially coupled to each other via the coupler shaft 131 such that when the first gear 14 synchronously rotate with the central gear 14, a shear stress is applied constantly onto one side of the first gear 14 and the coupler shaft 131 by virtue of tangential force of the gears 12, 14. The shear stress can cause untimely ruin of the central gear 12 as well as deformation of the coupler shaft 131. Thus, the output torque provided by the motor assembly at the beginning of the operation can not remain at a constant, thereby resulting in wobble of the gears and generating undesired noise. In other word, deformation of the coupler shaft 131 can result in jamming between the gears 12, 14. In addition, the conventional speed reduction system is bulky in size.

### SUMMARY OF THE INVENTION

The object of the present invention is to provide a speed reduction system which is capable of reducing speed in multi-steps so as to provide high speed ratio, thereby increasing the generated torque of the motor assembly employed in the speed reduction system.

In one aspect of the present invention, a speed reduction system is provided to include: a rotating source including an output shaft, a first ring gear, a first holding seat having a central axle, a first gear set disposed on the first holding seat in such a manner so as to be meshed with the first ring gear and coupled to the output shaft of the rotating source for co-rotation therewith, a second ring gear juxtaposed to the first ring gear, a second holding seat, and a second gear set disposed on the second holding seat in such a manner so as to be meshed with the second ring gear and coupled to the central axle of the first holding seat for co-rotation therewith. Activation of the rotating source results in synchronous rotation of the first gear set and the first holding seat, which, in turn, results in relative rotation between the second ring gear and second holding seat so as to provide a torque by virtue of interconnection between the central axle of the first holding seat and the second gear set.

In a second aspect of the present invention, a speed reduction system is provided to include: a rotating source including an output shaft, a ring gear, a first holding seat having a central axle, a first gear set disposed on the first holding seat in such a manner so as to be meshed with the ring gear and coupled to the output shaft of the rotating source for co-rotation therewith, a second holding seat, and a second gear set disposed on the second holding seat in such a manner so as to be meshed with the second ring gear and coupled to the central axle of the first holding seat for co-rotation therewith. Activation of the rotating source results in synchronous rotation of the first gear set and the first holding seat, which, in turn, results in relative rotation between the ring gear and second holding seat so as to provide a torque by virtue of interconnection between the central axle of the first holding seat and the second gear set.

In a third aspect of the present invention, a speed reduction system is provided for a wheel assembly that includes a hub housing consisting of a hub body and a cover plate for covering the hub body. The speed reduction system includes: a motor for disposing within the hub housing and having an output shaft, a first ring gear, a first holding seat having a central axle, a first gear set disposed on the first holding seat in such a manner so as to be meshed with the first ring gear and coupled to the output shaft of the motor for co-rotation therewith, a second ring gear juxtaposed to the first ring gear, a second holding seat, and a second gear set disposed on the second holding seat in such a manner so as to be meshed with the second ring gear and coupled to the central axle of the first holding seat for co-rotation therewith. Activation of the motor results in synchronous rotation of the first gear set and the first holding seat, which, in turn, results in relative rotation between the second ring gear and second holding seat so as to provide a torque by virtue of interconnection between the central axle of the first holding seat and the second gear set, the torque capable of rotating the hub housing.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is an exploded view of a conventional speed reduction system;

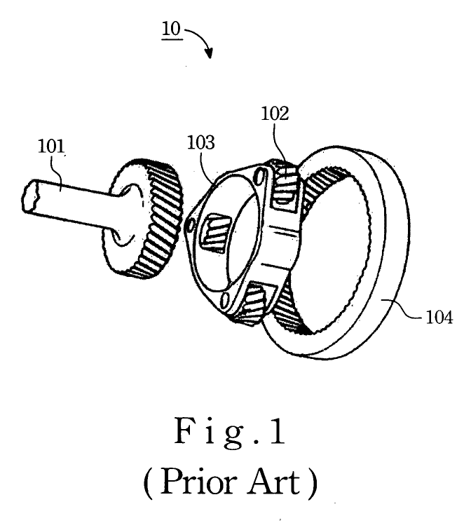

FIG. 2 is an exploded view of another conventional speed reduction system;

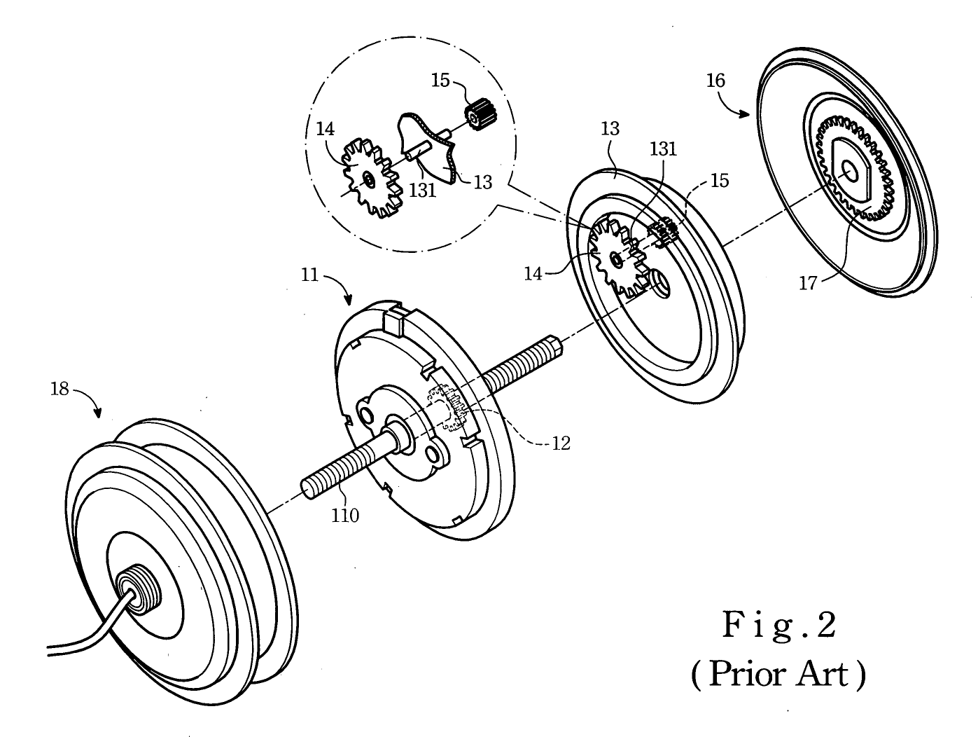

FIG. 3 is an exploded view of the first embodiment of a speed reduction system according to the present invention;

FIG. 4 is an exploded view of the second embodiment of the speed reduction system according to the present invention;

FIGS. 5A, 5B and 5C respectively illustrate a state of the second embodiment during operation;

FIG. 6 is a partly exploded view of the third embodiment of the speed reduction system according to the present invention;

FIG. 7A illustrates a first hub assembly provided with the speed reduction system of the present invention;

FIG. 7B illustrates a powered bicycle provided with the speed reduction system of the present invention;

FIG. 8 illustrates a second hub assembly provided with the speed reduction system of the present invention;

FIG. 9 illustrates a third hub assembly provided with the speed reduction system of the present invention; and

FIG. 10 illustrates a fourth hub assembly provided with the speed reduction system of the present invention.

### DETAILED DESCRIPTIONS OF THE PREFERRED EMBODIMENTS

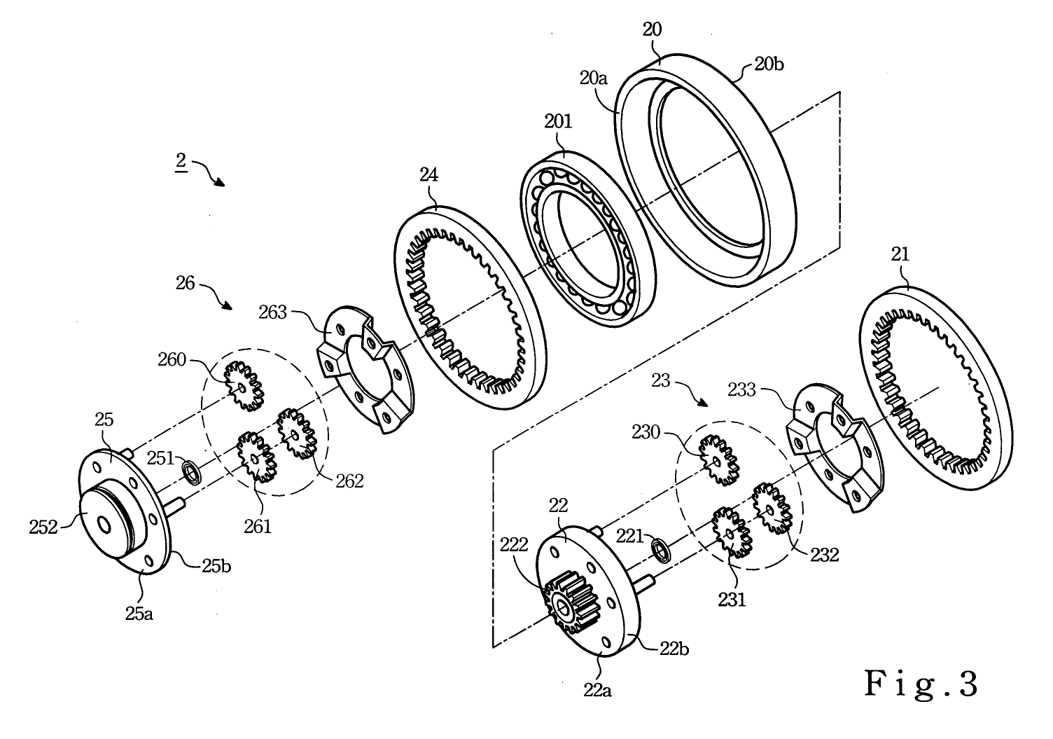

Referring to FIG. 3, the first embodiment of a speed reduction system 2 according to the present invention is shown to include a rotating source (not shown), a first ring gear 21, a first holding seat 22, a first gear set 23, a second ring gear 24, a second holding seat 25, a second gear set 26, and a hollow cylindrical casing 20.

As illustrated, the cylindrical casing 20 has opposite left and right sides 20a,20b. The first and second ring gears 21, 24 are juxtaposed within the cylindrical casing 20 by means of a common bearing 201 in such a manner that the first and second ring gears 21, 24 sandwich the common bearing 201 therebetween and that the first and second ring gears 21, 24 are disposed respectively adjacent to the left and right sides 20a, 20b of the cylindrical casing 20. The first and second ring gears 21, 24 respectively have a number of teeth different from each other or equivalent to each-other. The first holding seat 22 (generally a disc configuration) has a central axle 222, and is disposed rotatably within the common bearing 201. The first gear set 23 is disposed on a first side face 22b of the first holding seat 22 via a retention disc 233 so as to be meshed with the first ring gear 21. The first gear set 23 is further coupled operably to an output shaft of the rotating source (not shown in FIG. 3) for co-rotation therewith. The central axle 222 of the first holding seat 22 is preferably a splined shaft mounted centrally on a second side face 22a of the first holding seat 22. The rotating source can be an electrically driven motor or any other driving source.

The second holding seat 25 (generally a disc configuration) is disposed within the second ring gear 24. The second gear set 26 is disposed on a first side face of the second holding seat 25 via a retention disc 263 so as to be meshed with the second ring gear 24. The second holding seat 25 has a central projection 252 extending axially from a second side face 25a thereof and is coupled to the splined shaft of the first holding seat 22 by virtue of complement to its structure for co-rotation therewith. Under such arrangement, activation of the rotating source (not shown) results in synchronous rotation of the first gear set 23 and the first holding seat 22, which, in turn, results in a torque to cause relative rotation between the second ring gear 24 and the second holding seat 25. Note that the final torque provided by the first embodiment is relatively large since the rotation speed of the output shaft of the rotating source is reduced in two steps by the first and second gear sets 23, 26 with the assistance of the first and second ring gears 21, 24. Since the speed reduction system of the present invention occupies only a relatively small amount of space, it should be employed in those compact and portable machines in order to provide high torque. Each of the first and second holding seats 22, 25 is preferably provided with a seat bearing 221(2251) at its central portion thereof in order to reduce the undesired noise caused during rotation of the first and second holding seats 22, 25 with respect to the first and second ring gears 21, 24. In addition, the common bearing 201 enables stable retention of the first holding seats 22 with respect to the first ring gear 21 so as to reduce the wobble noise caused due to imprecise errors of teeth formed therebetween.

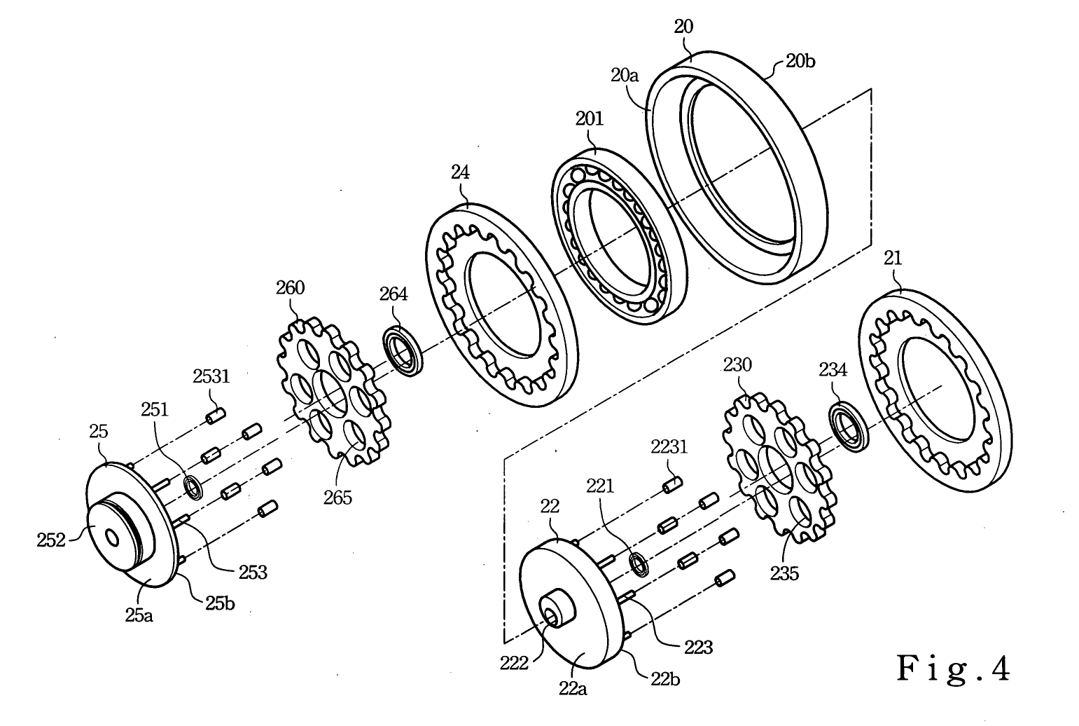

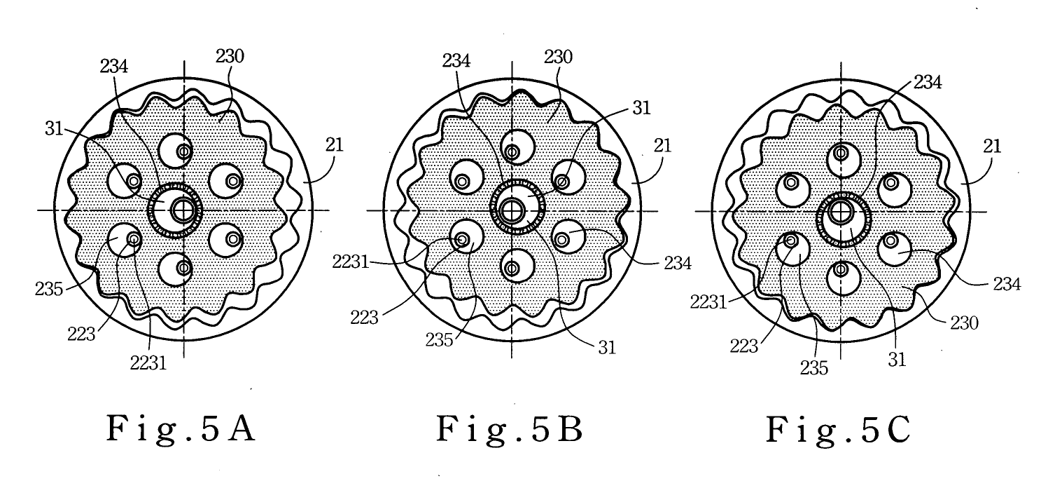

Referring to FIG. 4, in this embodiment, the first and second ring gears 21, 24 are fastened securely to the cylindrical casing 20 such that activation of the rotating source results in rotation of the second holding seat 25 with respect to the second ring gear 24. Each of the first and second gear sets 23, 26 includes a cycloidal gear 230(260) and a bearing 234(264) provided at a central portion of the cycloidal gear 230(260). Each of the cycloidal gears 230(260) is formed with a plurality of angularly spaced rotating holes 235(265). Each of the first and second holding seats 22(25) has a plurality of angularly spaced holding stems 223(253) formed on the first side face 22b(25b) and respectively extending into the rotating holes 235(265) in the cycloidal gears 230(260). The output shaft 31 of the rotating source (see FIGS. 5A, 5B and 5C) extends into the bearing 234 of the cycloidal gear 230 for eccentrically rotating the same. In order to facilitate driving of the first and second holding seats 22,25 with respect to the first and second ring gears 21,24, a plurality of cylindrical sleeves 2231(2531) are sleeved respectively around the holding stems 223(253) of the first and second holding seats 22,25. The cylindrical sleeves 2231(2531) serve as bearings to reduce friction caused during rotation of each of the holding seats 22,25 with respect to the ring gears 21(24).

Referring again to FIG. 3, each the first and second gear sets 23, 26 includes three planet gears 230,231,232 which are journalled on the first side face 22b(25b) of the holding seat 22(25) via the retention disc 233(263) and which are meshed with the ring gear 21(24).

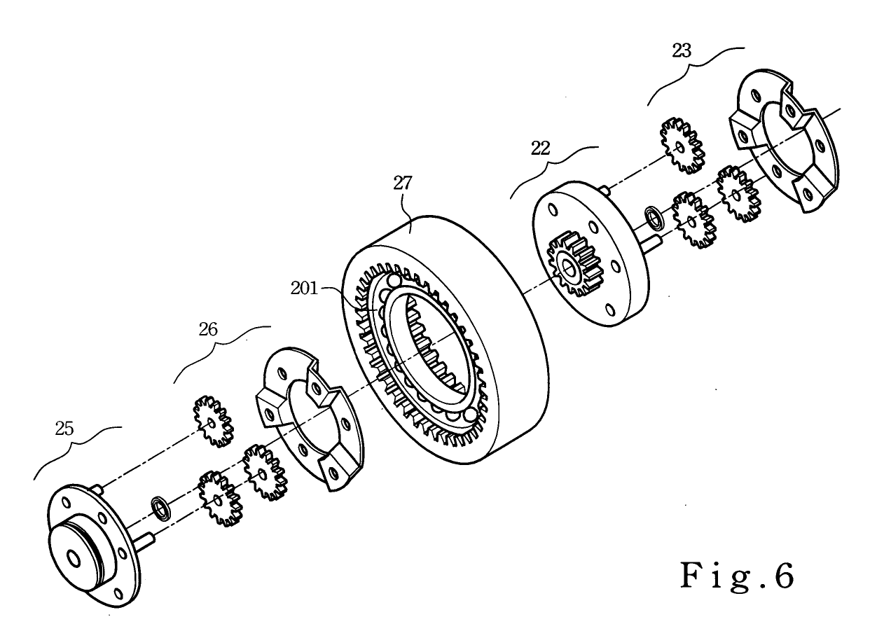

Referring to FIG. 6, another embodiment of the speed reduction system according to the present invention is shown to have the construction similar to that of FIG. 3. The main difference resides in that two opposite sides of the cylindrical casing 27 respectively define the first and second ring gears. In other words, the cylindrical casing and the first and second ring gears form a single unit in order to minimize storage space.

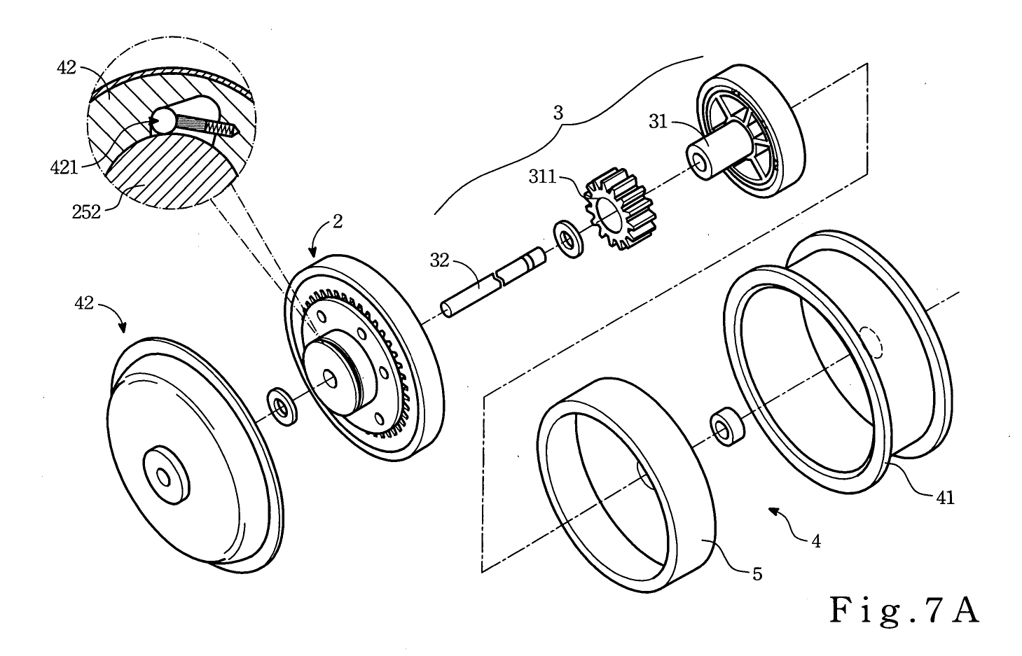

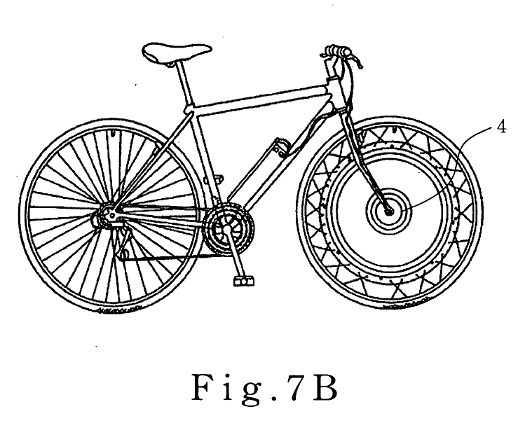

Referring to FIGS. 7A and 7B, the speed reduction system 2 of the present invention is employed in powered bicycle that includes a hub assembly 4 consisting of a hub body 41 and a cover plate 42 for covering the hub body 41. A motor assembly 3 is disposed within the hub housing 4. The second holding seat 25 is coupled to the hub housing 4 via a ratchet mechanism 421 for simultaneous turning with the hub housing 4 in a single direction. The motor assembly 3 includes motor casing 5, an output shaft 31, a mounting shaft 32 extending through the motor casing 5 for journaling to the hub body 41 and the cover plate 42.

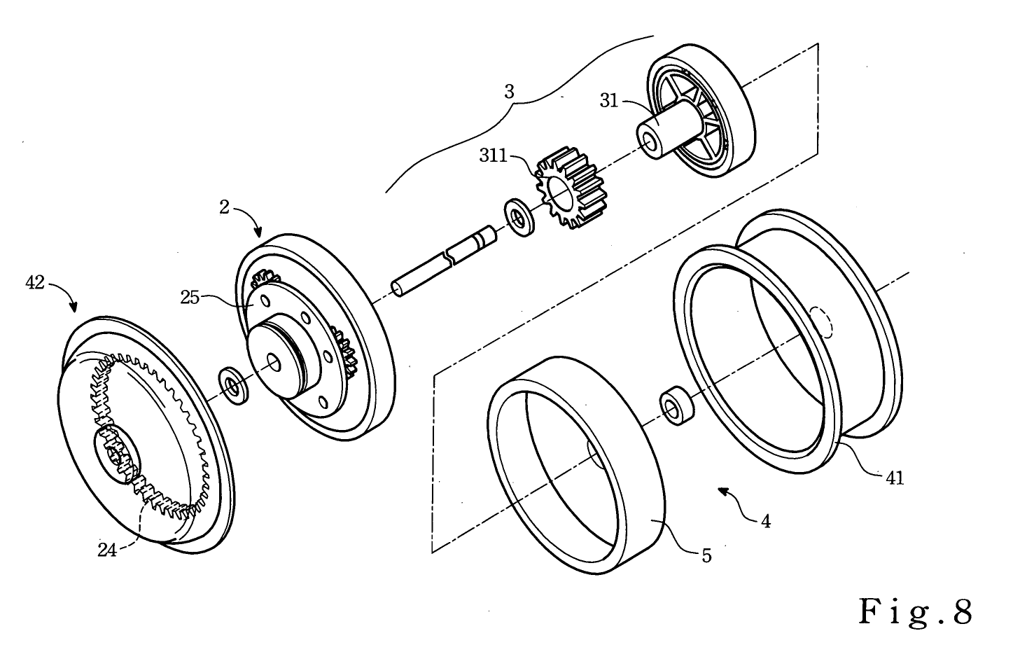

FIG. 8 shows an exploded view of the second hub assembly 4 provided with the speed reduction system 2 of the present invention. The second hub assembly 4 has the construction similar to that of FIG. 7, except that the second ring gear 24 is integrally formed with the cover plate 42 while the second holding seat 25 is fixed on the mounting shaft 32 such that the hub housing 4 is driven with respect to the second holding seat 25 upon activation of the motor assembly 3.

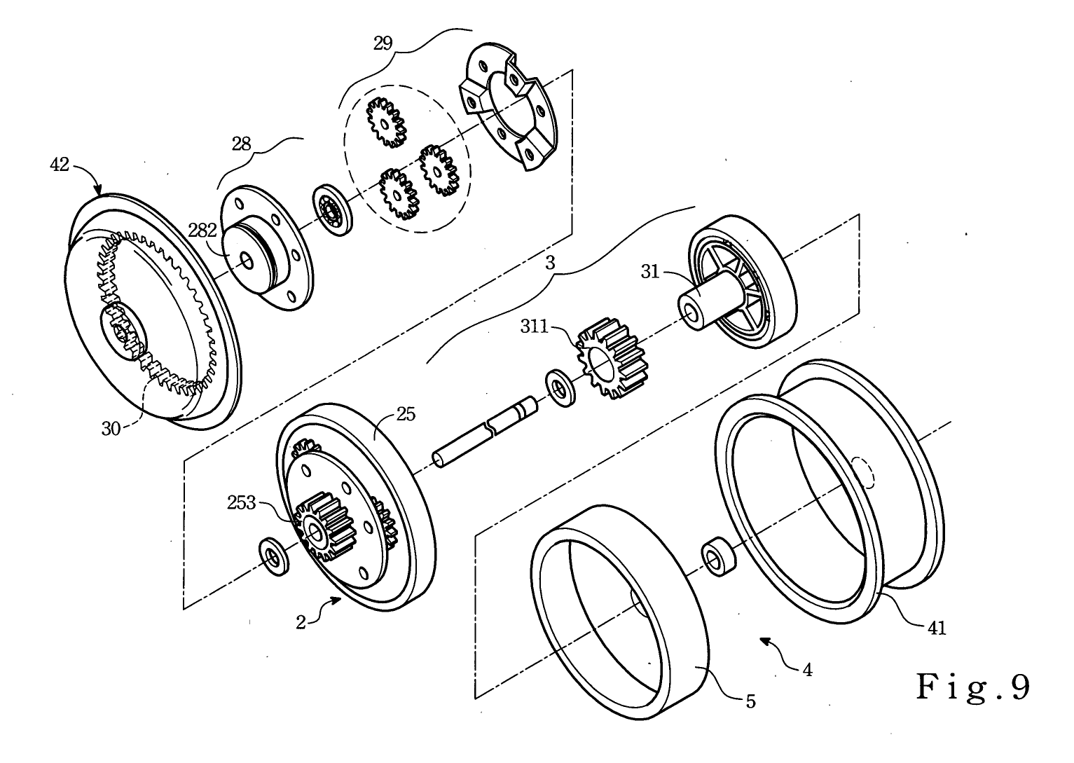

FIG. 9 shows an exploded view of the third hub assembly 4 provided with the speed reduction system 2 of the present invention. The third hub assembly 4 has the construction similar to that of FIG. 8, except that it further includes a third holding seat 28 and a third gear set 29 mounted on the third holding seat 28 via a retention disc so as to be meshed with the third ring 30. In order to complement with the central projection 282 of the third holding seat 28, the central projection 253 of the second holding seat 25 is constructed in the splined shaft configuration for coupling to the third holding seat 28.

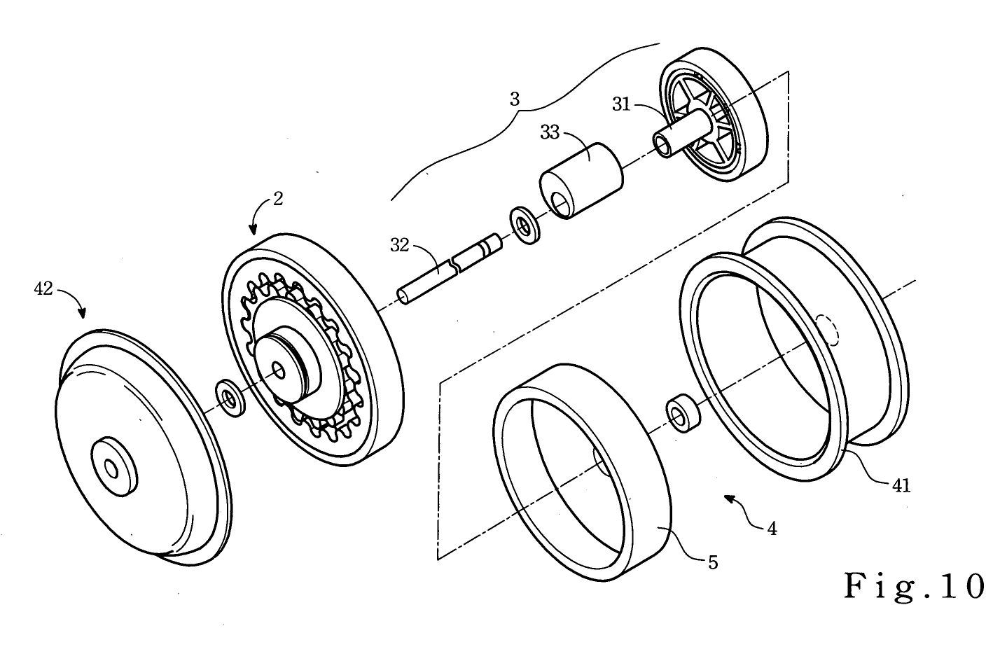

FIG. 10 shows an exploded view of the fourth hub assembly 4 provided with the speed reduction system 2 of the present invention. The fourth hub assembly 4 has the construction similar to that of FIG. 7, except that it further includes an eccentric coupler shaft 33 fixed on the output shaft 31 of the motor assembly 3 in such a manner that the eccentric coupler shaft 33 extends into the first gear set 23 (i.e. the cycloidal gear 230) such that activation of the motor assembly 3 eccentrically drives the second holding seat 25 (see FIGS. 5A to 5C), thereby rotating the hub assembly 4.

With the utility of the speed reduction system 2 of the present invention, the dimension of the ring gear is not increased laterally (i.e. in the radial direction). Though the thickness thereof will be slightly increased due to addition of the gear set, the torque provided thereby is considerably large such that the speed reduction system of the present invention should be utilized in compact motor assembly. In addition, by employment of a plurality of planet gears around the sun gear, the force applied onto the coupler shaft (hence the output shaft) is uniformly distributed so as to reduce the burden on the output shaft, thereby prolonging the service life of the ring gears and the planet gears in addition to providing high torque.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A speed reduction system comprising:
a rotating source including an output shaft;
a first ring gear;
a first holding seat having a central axle;
a first gear set disposed on said first holding seat in such a manner so as to be meshed with said first ring gear, and coupled to said output shaft of said rotating source for co-rotation therewith;
a second ring gear juxtaposed to said first ring gear;
a second holding seat; and
a second gear set disposed on said second holding seat in such a manner so as to be meshed with said second ring gear, and coupled to said central axle of said first holding seat for co-rotation therewith;
whereby, activation of said rotating source results in synchronous rotation of said first gear set and said first holding seat, which, in turn, results in relative rotation between said second ring gear and second holding seat so as to provide a torque by virtue of interconnection between said central axle of said first holding seat and said second gear set.

2. The speed reduction system according to claim 1, wherein said first gear set includes a cycloidal gear and a bearing provided at a central portion of said cycloidal gear, said output shaft of said rotating source extending into said bearing for eccentrically rotating said cycloidal gear, said cycloidal gear further having a plurality of angularly spaced rotating holes, said first holding seat having a side face formed with a plurality of angularly spaced holding stems extending respectively into said rotating holes in said cycloidal gear in such a manner that relative rotation between said cycloidal gear and said first ring gear results in rotation of said first holding seat.

3. The speed reduction system according to claim 1, wherein said second gear set includes a cycloidal gear and a bearing provided at a central portion of said cycloidal gear, said central axle of said first holding seat extending into said bearing for eccentrically rotating said cycloidal gear, said cycloidal gear further having a plurality of angularly spaced rotating holes, said second holding seat having a side face formed with a plurality of angularly spaced holding stems extending respectively into said rotating holes in said cycloidal gear in such a manner that relative rotation between said cycloidal gear and said second ring gear results in rotation of said second holding seat.

4. The speed reduction system according to claim 1, wherein said first gear set includes a plurality of planet gears which are journalled on a side face of said first holding seat and which are operably associated with said output shaft of said rotating source in such a manner that activation of said rotation source results in rotation of said first holding seat.

5. The speed reduction system according to claim 1, wherein said second gear set includes a plurality of planet gears which are journalled on a side face of said second holding seat and which are operably associated with said central axle of said first holding seat in such a manner that activation of said central axle results in relative rotation between said second ring gear and said second holding seat.

6. The speed reduction system according to claim 5, wherein said second ring gear is disposed stationarily relative to said second holding seat such that rotation of said planet gears results in turning of said second holding seat.

7. The speed reduction system according to claim 5, wherein said second holding seat is disposed stationarily relative to said second ring gear such that rotation of said planet gears results in turning of said second ring gear.

8. The speed reduction system according to claim 4, wherein said first gear set further includes a retention disc via which said planet gears are journalled onto said side face of said first holding seat.

9. The speed reduction system according to claim 5, wherein said second gear set further includes a retention disc via which said planet gears are journalled onto said side face of said second holding seat.

10. The speed reduction system according to claim 5, wherein said central axle of said first holding seat is a splined shaft, said second holding seat having a central projection 252 complementing to said splined shaft of said first holding seat.

11. The speed reduction system according to claim 1, wherein said first and second ring gears respectively have a number of teeth different from each other.

12. The speed reduction system according to claim 1, wherein said first and second ring gears respectively have a number of teeth equivalent to each other.

13. The speed reduction system according to claim 1, further comprising a hollow cylindrical casing having opposite left and right sides, said first and second ring gears being juxtaposed within said cylindrical casing respectively adjacent to said left and right sides of said cylindrical casing.

14. The speed reduction system according to claim 13, further comprising a common bearing sandwich between said first and second ring gears, said first holding seat extending into said common bearing.

15. The speed reduction system according to claim 1, further comprising a seat bearing disposed centrally of said first holding seat.

16. The speed reduction system according to claim 1, further comprising a seat bearing disposed centrally of said second holding seat.

17. A speed reduction system comprising:
a rotating source including an output shaft;
a ring gear;
a first holding seat having a central axle;
a first gear set disposed on said first holding seat in such a manner so as to be meshed with said ring gear, and coupled to said output shaft of said rotating source for co-rotation therewith;
a second holding seat; and
a second gear set disposed on said second holding seat in such a manner so as to be meshed with said second ring gear and coupled to said central axle of said first holding seat for co-rotation therewith;
whereby, activation of said rotating source results in synchronous rotation of said first gear set and said first holding seat, which, in turn, results in relative rotation between said ring gear and second holding seat so as to provide a torque by virtue of interconnection between said central axle of said first holding seat and said second gear set.

18. A speed reduction system for a wheel assembly that includes a hub housing consisting of a hub body and a cover plate for covering the hub body, the speed reduction system comprising:
a motor for disposing within the hub housing, and having an output shaft;
a first ring gear;
a first holding seat having a central axle;
a first gear set disposed on said first holding seat in such a manner so as to be meshed with said first ring gear, and coupled to said output shaft of said motor for co-rotation therewith;
a second ring gear juxtaposed to said first ring gear;
a second holding seat; and
a second gear set disposed on said second holding seat in such a manner so as to be meshed with said second ring gear, and coupled to said central axle of said first holding seat for co-rotation therewith;
whereby, activation of said motor results in synchronous rotation of said first gear set and said first holding seat, which, in turn, results in relative rotation between said second ring gear and second holding seat so as to provide a torque by virtue of interconnection between said central axle of said first holding seat and said second gear set, said torque capable of rotating the hub housing.

19. The speed reduction system according to claim 18, wherein said motor includes a hollow cylindrical casing that is disposed securely within the hub housing and that has opposite left and right sides, said first and second ring gears being juxtaposed within said cylindrical casing respectively adjacent to said left and right sides of said cylindrical casing.

20. The speed reduction system according to claim 19, further comprising a common bearing sandwiched between said first and second ring gears, said first holding seat extending into said common bearing.

21. The speed reduction system according to claim 20, further comprising a ratchet mechanism, said second holding seat being coupled to the hub housing via said ratchet mechanism for simultaneous turning with the hub housing in a single direction.

22. The speed reduction system according to claim 21, further comprising a third ring gear, a third holding seat and a third gear set, said third ring gear being integrally formed with the cover plate, said third gear set being disposed on a side face of said third holding seat in such a manner to be associated operably with said third ring gear and said second holding seat in such a manner that synchronous rotation of said second holding seat and said third ring gear results in turning of the hub housing.
